(19) United States
(12) Patent Application Publication
(10) Pub. No.: US 2017/0091388 A1
(43) Pub. Date: Mar. 30, 2017

(54) SYSTEMS AND METHODS SUPPORTING INTEROPERABILITY AMONG HEALTH RECORD APPLICATIONS AND DATA SOURCES

(71) Applicant: Stratus Interoperable, Inc., Nanuet, NY (US)

(72) Inventors: Frederick H. ZOLLA, Nanuet, NY (US); Lynn D. SMITH, Nanuet, NY (US)

(21) Appl. No.: 14/870,664

(22) Filed: Sep. 30, 2015

(51) Int. Cl. G06F 19/00; G06F 17/30; G06Q 30/02

(52) U.S. Cl. CPC G06F 19/322; G06Q 30/0201; G06F 17/30424

(57) ABSTRACT

Described herein are systems and methods for receiving healthcare data from a plurality data sources that generate and store data in various data model regimes, many of which are not standardized or are variants of a standard. Application interfaces may access preconfigured schema files defining the data fields of each particular data model associated with a data source. Records may be received from data sources, parsed or tagged according to logical domains, and stored into any number of repositories. The repositories may include a master repository that stores master records for each unique patient, comprising the collective data received from the various data sources.

### TECHNICAL FIELD

This application relates generally to healthcare and healthcare related software applications, and enterprise data management.

### BACKGROUND

Electronic healthcare records (EHR) are generated and stored according to various data models. In some cases, the data models may be standards across the industry, such as HL7. But often healthcare related applications do not utilize a standardized data model. In a similar vein, healthcare software applications may use variants of standard data models or customized data models that are not openly available. This is particularly prevalent in the long term health care industry where each patient's provider typically employs a different vendor for its data management. This results in a disparate set of data storage and reports for each patient, which can be problematic because entities may not be able to translate data prepared under one data model to another data model, without knowing how the data is structured in its existing software applications or without a license from the vendor of the specific data model. Having a patient's records spread across separate and often incompatible data systems effectively precludes the ability to obtain a comprehensive set of medical records for the patient in an efficient and cost effective manner. To the patient's detriment, this leads to the inability to procure an accurate and comprehensive 360° view of a patient's health records.

Governmental entities at all levels, as well as software and healthcare industry participants generally recognize the benefits to data interoperability, and so there are often efforts to standardize data models or to generate an open data model. These efforts have led to the development of conventional tools, which improve the circumstances, but ultimately fall short.

For example, MirthConnect® was created as an open source solution (though it is now proprietary) for transmitting healthcare data between disparate systems. It is configured to provide interoperability across systems, by creating standard data formats. However, it is merely a connectivity solution among devices. It is unable to address larger volumes of data. That is, it cannot provide efficiencies associated with dynamic data management techniques. It merely converts data, but falls short in robust data manipulation, so that outputted data may be efficiently and effectively tailored for specific destination data models. Moreover, because it lacks in data manipulation and data modeling functions, it is unable to continuously update or store data records over time. In addition, because it cannot track changes in data over time, it is unable to determine whether newly received records contain inaccuracies or are defined by new data models.

As another example, Laika® was developed as an open source means for testing interoperability between healthcare devices. However, this is merely a testing tool used to verify whether a software application under development is compliant with voluntary data modeling standards. It is unable to actually provide interoperability between systems. Moreover, it is unable to actually produce outputted data converted from data models of disparate systems. Other software applications, such as PopHealth® have tried to standardize the manner in which EHRs are generated by various analytics systems. However, PopHealth®, which uses the standardized HL7 healthcare data format, does not provide for interoperability when the inputted data is not in the HL7 format.

Ultimately, large quantities of data may be trapped EHRs formatted according to data models of a proprietary software application. What is needed is a means for consuming large quantities of data records and efficiently providing that data in a useable format. But what is also needed is a means for continuously consuming new healthcare records, from disparate systems using various data models, ubiquitous in the long term care health industry, storing that data in a way that may be outputted according to any data model, able to provide for error correction and detection, and achieve an output of the data formatted according to any number of data models for analytics systems.

### SUMMARY

Described herein are systems and methods that address the above-described shortcomings in the relevant technical field. The systems and methods described herein offer agnostic interoperability among various healthcare and healthcare related software applications and data model. Embodiments may receive patient healthcare data from a plurality of disparate data sources that generate and store data using a variety of data models, many of which are not standardized or are variants of a standard. Application interfaces may access preconfigured schema files defining the data fields of each particular data model associated with a data source. Records may be received from data sources, parsed or tagged according to logical domains, and stored into any number of repositories. The repositories may include a master repository that stores master records for each unique patient, comprising the collective data received from the various data sources. Inbound data interfaces may consume data records (i.e., inbound records) in real-time or at predetermined intervals, from disparate systems. The inbound interfaces may reference schema files defining the various data models of the inbound records, to then tag or parse into smaller databases certain data fields into sets of data fields (i.e., domains). The inbound data interfaces may identify inbound records that are related to the same patients, and assign unique patient identifiers (patient IDs) to each inbound record. Inbound records related to the same patient are assigned the same patient ID. A unification engine may generate or update master records using the data fields of the inbound records, which are now tagged or parsed by domain, as well as tagged or parsed by patient ID. The unification engine may merge together domains (i.e., data fields) assigned the same patient ID, thereby forming master records. Outbound schema files may define which domains and/or which patient IDs are expected by destination devices. The destination devices may have disparate data models, which may or may not be the same as the data models of data sources. The outbound schema files may provide for agnostic data outputs, such that the data in the master repository, or any other repository, may be structured and transmitted to the destination devices according to any data model required.

In one embodiment, a computer-implemented method to achieve interoperability between disparate electronic health record systems, the method comprising: receiving, by a computer, one or more inbound records from one or more source devices, wherein each respective inbound record is received from a source device and comprises one or more data fields; for each respective inbound record, identifying, by the computer, one or more domains in the inbound record according to a schema file configured for the inbound record, each domain defined by a set of one or more data fields of the inbound record, wherein at least one domain in the inbound record is a demographics domain; assigning, by the computer, a unique patient identifier (patient ID) to each respective inbound record, wherein a set of two or more inbound records are assigned the same patient ID when the data in the demographics domain of each respective inbound record in the set of two or more inbound records satisfies a matching threshold value; parsing, by the computer, each inbound record into the one or more sets of data fields defining the one or more domains identified in the respective inbound record, wherein respective set of data fields is associated with the patient ID; for each respective patient ID: merging, by the computer, into a master record identified by the respective patient ID the one or more sets of data fields defining the one or more domains; and generating, by the computer, the master record in a master repository.

In another embodiment, A system to achieve interoperability between disparate electronic health record systems in long term care, the system comprising: one or more inbound schema files defining one or more data fields of one or more inbound records and indicating one or more sets of the one or more data fields correspond to one or more domains; an application programming interface executed by a server configured to receive one or more inbound records from one or more data sources, identify one or more data fields in each inbound record according to a schema file configured for the inbound record, and identify one or more domains in the one or more data fields of each respective inbound record according to the schema file; a server executing a unification engine configured to merge one or more sets of data fields corresponding to domains for each set of data associated with a patient identifier (patient ID), and generate or update a master record in a master repository for each patient ID comprising at least one set of data fields for at least one domain for each set of data fields corresponding to the respective patient ID; and an outbound interface configured to transmit one or more outbound records containing one or more data fields of domains parsed from one or more master records of the master repository according to an outbound schema file associated with one or more destination devices.

In another embodiment, a system for providing interoperable electronic health records between disparate data sources, the system comprising a data management server executing a plurality of inbound interfaces configured for a plurality of data sources, the data management server configured to: receive one or more inbound records from one or more data sources: assign a unique patient identifier (patient ID) to each inbound record comprising distinct data in a set of demographics data fields of the inbound record; identify, in each respective inbound record, one or more sets of one or more data fields belonging to one or more domains; and transmit to one or more destination devices one or more outbound records comprising one or more data fields of one or more domains, in accordance with one or more outbound schema files defining the one or more data fields for the one or more destination devices; and a mobile device comprising a processor executing a mobile application operating according to a first data model, the mobile device configured to: receive from the data management server an outbound record comprising a set of one or more data fields in one or more domains defined by a first schema file configured for the first data model, and display the data of at least one data field of the outbound record on an interactive graphical user interface operated via the mobile application.

It is to be understood that both the foregoing general description and the following detailed description are exemplary and explanatory and are intended to provide further explanation of the invention as claimed.

### BRIEF DESCRIPTION OF THE DRAWINGS

The accompanying drawings constitute a part of this specification and illustrate an embodiment of the invention and together with the specification, explain the invention.

FIG. 1 shows components of an exemplary healthcare data clearinghouse system, according to an exemplary system embodiment.

FIG. 2 shows components and organization of an exemplary architecture of an exemplary system embodiment.

FIG. 3 shows an exemplary method for data handling, as performed by one or more data management servers executing one or more interface modules.

FIG. 4 shows data flow between devices of a clearinghouse system, according to an exemplary embodiment.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

Reference will now be made to the exemplary embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to one skilled in the relevant art and having possession of this disclosure, are to be considered within the scope of the invention.

Exemplary Healthcare Data Clearinghouse Systems

Exemplary Components

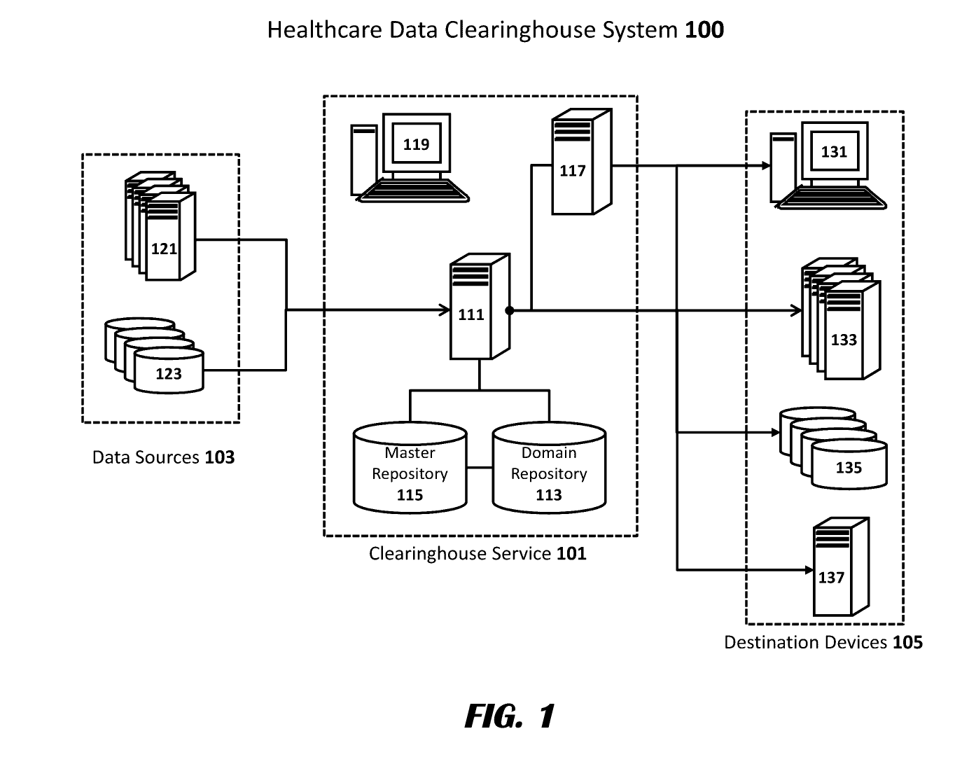

FIG. 1 shows components of an exemplary healthcare data clearinghouse system 100, which may include a clearinghouse service 101, data sources 103, and data destinations 105. The clearinghouse service 101 may receive data, such as electronic healthcare records, from a variety of data sources 103. The clearinghouse service 101 may convert the arriving data into a standardized data model, which may then be repackaged for distribution to various data destinations 105 in nearly any number of formats. The clearinghouse service 101 may generate a Master Repository 115 of integrated records for each patient having one or more records in the data sources 103. The data may be published or otherwise distributed through any number of distribution channels, to data destinations 105 associated with one or more subscribing entities.

A data clearinghouse service 101 may comprise a data management server 111, a domain repository 113, a master repository 115, a webserver 117, and an administrator device 119. The data management server 111 may receive inbound data records from data sources 103 and may convert the inbound data from a source model to a standard model, using one or more application programming interfaces (APIs) that map the data fields of the inbound data to the data fields of a standard model.

In some embodiments, the clearinghouse service 101 may comprise a backup repository (not shown) where one or more inbound records from data sources 103 may be stored for redundancy, data model baseline references, and a locally stored version for reference that is more efficiency referenced and/or manipulated than consistently requesting the data from the data source 103. The backup repository may be configured to store data for particular data sources 103, such that the data in the inbound records are segregated, and are stored according to the data model of the particular data source 103. For example, records arriving from a data source 103 employing a healthcare application (e.g., AllScripts®) may provide inbound records having a first data model (e.g., HL7). These inbound records would then be stored into a table, instance, partition, or other segment of the backup database configured to store data from the first data source 103, according to the native data model of that data source 103.

In some embodiments, the clearinghouse service 101 may comprise a queuing or intermediate repository (not shown) that may store copies of inbound records, but may then be manipulated by the various software modules described herein (e.g., inbound interfaces). That is, in some implementations, the clearinghouse service 101 may employ an intermediate repository to function as a “sandbox,” where copies of the original inbound records may be parsed, merged, or otherwise manipulated, without disrupting the integrity of the original data. In some embodiments, this type of intermediate repository may be a domain repository 113; and in some embodiments, domain repositories 113 may be distinct locations where parsed data sets are stored according to outbound schemas associated with certain destination devices 105.

A data management server 111 may be any computing device comprising a processor and non-transitory machine-readable storage media storing software modules that instruct the processor to execute the various processes and tasks described herein. Non-limiting examples of a data management server 111 may include a workstation computer, a server computer, a laptop, and a tablet device. The data clearinghouse service 101 may comprise any number of data management servers 111, a subset of which may be configured to expressly service certain data sources 103 and/or certain destination devices 105.

The software modules executed by the data management server 111 may include interface modules configured to consume (e.g., retrieve/pull, receive) from data sources 103 inbound data records to be parsed and reconstructed into a useable format for any subscribing destination devices 105. The interface software modules may be configured to receive or pull data from particular data sources 103, as required by the particular data source 103. For example, in some cases, a data source 103 may be configured to transmit a set of database records on a daily basis, via, say, an FTP or SFTP protocol. In such cases, the interface modules may be configured to accept the database records through the relevant data port and store the inbound records into a queuing database for later processing. In some cases, the interface modules may include message-oriented transaction software, such as RabbitMQ®, Apache ActiveMQ®, or the like, which may facilitate communication between a data source 103 and the data management server 111. In such cases, the messaging software may indicate to the data management server 111 that data records of a data source 103 have been generated or updated, thereby prompting the data management server 111 to request the new or updated records from the data source 103. Alternatively, the messaging software may be used by the data source 103 to transmit the new or updated data records in real-time or near real-time to the data management server 111. Messages may be handled by interface modules, such as MirthConnect®, which may be configured to filter, transform, and/or route messages from data sources 103 to the data management server 111.

Using inbound data records received from the various data sources 103, the software modules executed by the data management server 111 may generate database records for domain repositories 113 and/or a master repository 115. In some instances the data management server 111 may also store inbound records into backup databases configured for inbound records received from each particular data source 103. To generate the domain data records and/or master records, the data management server 111 may execute interface modules that reference inbound record specifications, which may be a computer file containing a schema file configured to interpret inbound records having a particular data model. Data models may define the data fields of inbound records and/or the data fields of domains. Schema files may be interface modules themselves or may machine-readable computer files used to by the interface modules for translation purposes. For example, a schema file may be an executable API script file, an XSL schema file, or other machine-readable file containing code that defines a data model for inbound records. The data management server 111 may execute inbound interface modules to perform any number of actions on certain fields of an inbound record, by referencing the schema file associated with the data source 103 to identify the requisite data fields of the inbound record.

For example, an inbound interface software module of the data management server 111 may compare certain fields of two inbound data records arriving from disparate data sources 103, to determine whether the two inbound records are related to the same patient. In this example, the software module may require demographic data fields to match with enough precision to satisfy a matching threshold. The demographic data fields are identified by schema files configured for each data model of the respective data sources 103, thereby allowing the data management server 111 to compare the appropriate data fields of each inbound data record. In a similar example, an inbound interface software module may compare certain fields of a new inbound data record arriving from a data source 103, against data fields of an existing data record that is stored in the master repository 115, domain repository 113, backup database, and/or queuing database. That is, the comparison may be made to determine whether the new inbound record is related to the same patient of an existing record stored somewhere in the clearinghouse 101. In this example, the software module may require the demographic fields of the new inbound record to match with enough precision to satisfy the matching threshold of demographic fields associated with a unique patient identifier (patient ID) that is associated with any number of database records in the clearinghouse service 101, for each record or set of data fields related to the same patient. For instance, the new inbound record, and any sets of data fields that may be parsed from the new inbound record, may be assigned a particular patient ID when the demographics data fields match, to a predefined degree (i.e., threshold), the demographics fields of any record already assigned the particular patient ID, such as a master record for the patient stored in the master repository 115.

Some embodiments of a clearinghouse service 101 may comprise one or more domain repositories 113 hosted on one or more computing devices, such as server computers, workstation computers, laptops, and tablets. A domain repository 113 may store data records comprising data fields that are associated with particular domains, which are logical organizations of related data fields. For example, a domain for Patient Demographics may include data fields of a patient's name (first, middle, last), social security number, Medicare number, Medicaid number, gender, data of birth, address, and any other identifying information. As another example, a domain for Providers may include data fields related to treatments and events associated with medical providers, such as tests, lab results, diagnoses, procedures, and other fields related to treatment. Other domains may be possible as well.

One or more schema files configured for particular data sources 103 may indicate to the data management server 111 which data fields of an inbound record are associated with which domains. In some embodiments, the data management server 111 may parse or copy certain data fields of an inbound record into distinct records of a domain repository 113, in accordance with the schema file configured for the inbound record. For example, an inbound record arriving from a physical therapy office that uses, say, the Casamba® physical therapy software application, may comprise data fields defined by Casamba's® data model. In this example, the data management server 111 may execute an interface module configured to receive and recognize the fields of the inbound record using a schema file configured for Casamba's® data model. The schema file may indicate for the data management server 111 that certain fields belong in a domain for patient demographics and certain fields belong in, say, a domain for physical therapists. As mentioned, in some embodiments, the data management server 111 may parse or copy the data fields into corresponding domain repositories 113, which may be distinct databases or may be database tables of a larger database.

Additionally or alternatively, in some embodiments, the data management server 111 may associate domain tags with the data fields of a domain as indicated by the schema file. In some implementations, the data management server 111 may update data fields of the inbound records to include or otherwise indicate, a particular field, of a particular inbound record, is included in a particular domain. In some implementations, the domain repositories 113 may be populated by copying those fields of inbound records associated with the domain tag. In some implementations, rather than being a database, the domain repository 113 may function as filtered view of the data fields of records tagged as belonging to the domain. In some implementations, rather than storing whole records, the domain repository 113 may store pointers to particular inbound records and/or fields stored in a queuing database or stored in a replicated database storing copies of inbound records received from data sources 103.

In some embodiments, the data management server 111 may identify when the data fields of inbound records received from a particular data source 103 vary from the data model defined by the schema file for the particular data source 103. In such embodiments, the data management server 111 may be configured to transmit a notification of the variance to a graphical interface of an administrator device 119. Additionally or alternatively, the data management server 111 may be configured to dynamically revise the schema file to comply with the data fields of one or more recent inbound records that have arrived from the data source 103. For example, the data management server 111 may identify that a treatment field has been split into two fields, when comparing the data fields of newly received inbound records from a data source 103, against the data fields expected according to the schema file for the data source 103. After identifying a certain number of the same changes in a threshold number of inbound records from the data source 103, the data management server 111 may automatically revise the schema file for the data source 103 so as to comply with the newly-identified data fields.

It should be appreciated that, although the exemplary system 100 shows only one domain repository 113, the clearinghouse service 101 may comprise zero or more domain repositories 113. That is, in some embodiments the clearinghouse service 101 may not implement a domain repository 113, but may instead tag or otherwise indicate certain fields of inbound records as part of a domain, without generating a domain database 113 that contains domain-relevant data fields. Moreover, in some implementations, the clearinghouse service 101 may generate a new, distinct domain repository 113 instance for a data source 103 or destination 105. For example, a client hospital desiring to convert its database records having a data model of a legacy software application, to an application-neutral format, may receive a dedicated instance of a cloud-based domain repository 113. As such, for those embodiments comprising a domain repository 113, the clearinghouse service 101 may comprise any number of domain repositories 113 or instances of cloud-based domain repositories 113.

The clearinghouse service 101 may comprise one or more master repositories 115 hosted on one or more computing devices, such as server computers, workstation computers, laptops, and tablets. A master repository 115 may store master data records for a patient. A master data record may contain data related to a single patient received from each data source 103 having data about that patient. A data management server 111 may generate a master data record for a patient by identifying each inbound record related to the patient and then assigning a unique patient identifier (patient ID) to each inbound record determined to be related to the patient. The data management server 111 may then generate one or more master data records for the patient, each having the patient ID, and containing data populated from the various inbound records assigned the patient ID. In some implementations, the data management server 111 may insert a “patient ID” data field into each inbound record determined to be related to the patient and stored in a queuing database. In some implementations, the data management server 111 may generate a new master record entry for each event (e.g., visit to a hospital). In some implementations, the data management server 111 may generate, or update particular fields of, a master record for a patient's treatment history for a particular condition. A master repository 115 may be updated when a new inbound record is identified as containing demographics data matching the demographics data of a master record for a patient ID, when the match satisfies a threshold value. In some cases, the data management engine will assess each new inbound record individually, to determine whether the inbound record is related to the same patient as an existing record. In some cases, the data management engine will identify a group of one or more inbound records as being related to the same patient, and then may compare the data in the group of inbound records against the existing records, to determine whether the group of records should be assigned a new patient ID or should be assigned an existing patient ID.

For example, if a patient has a broken leg, then the clearinghouse service 101 may receive data records from data sources 103 including a software application of a hospital (e.g., EPIC®, McKesson®) and a software application of a physical therapist (e.g., Casamba®). In this example, the data management server 111 may identify the fields of each respective inbound record as belonging to a particular domain (e.g., demographics, hospital provider, physical therapy provider), using the schema file configured for each inbound record's data model. The data management server 111 may then determine which of the inbound data records are related to the same patient. These records may comprise fields containing medical industry-standard codes or terms indicating that the inbound records pertain to the same history of treatment for the broken leg. The inbound records may then be joined to form a master record of a patient accordingly. In some embodiments, one or more servers may execute a unification engine, which may include a data management server 111 or a server hosting the master repository 115. The unification engine may comprise one or more software modules configured to identify sets of data fields corresponding to domains that are to be merged into master records. The unification engine may generate or update records of a master repository by merging data in data fields of the particular domains, for those data fields assigned to a common patient ID. In some instances, the domains may only comprise mutually-exclusive data fields and thus there are no duplicative data points. Additionally or alternatively, the unification engine may identify and discard overlapping data fields from the master records.

In some implementations, a master record for a patient may contain data fields for each inbound record that is assigned the same patient ID. Additionally or alternative, the data fields in the master record may contain pointers to certain fields of the inbound records having the patient ID stored in the queuing database. In such implementations, the data in the master repository 115 is not yet “structured” (i.e., organized or formatted) according to any particular data model. As such, the same or different data management server 111 may execute an outbound interface software module that structures certain portions of the data stored in a master record of a patient according to a schema file configured for the data model of a particular application or database hosted on a destination device 105.

In some cases, the data management server 111 may reference the domain of a particular set of data fields to structure a master record. Domains may define mutually-exclusive or overlapping data fields. In embodiments where a data management server 111 or some other software engine capable of querying the master repository 115, structures master records according to an outbound schema file, the outbound schema file may indicate which domain and/or data fields are required for the data model associated with the destination device 105. The data management server 111 may then generate one or more master records for the patient formatted according to requisite data model. That is, the data management server 111 queries each domain's data field and then performs a union or exclusive disjunctive (i.e., either one, but not both) operation on the sets of data fields identified by the domains. The result of this operation is a non-duplicative set of data fields defined by each domain, where the data in the data fields are culled from the inbound records assigned the patient ID.

It should be appreciated that, although the exemplary system 100 shows only one master repository 115, the clearinghouse service 101 may comprise one or more master repositories 115. That is, in some implementations, the clearinghouse service 101 may generate a new, distinct master repository 115 instance for a data source 103 or destination 105. For example, a client hospital desiring to convert its database records having a data model of a legacy software application, to an application-neutral format, may receive a dedicated instance of a cloud-based master repository 115. As such, the clearinghouse service 101 may comprise any number of master repositories 115 or instances of cloud-based master repositories 115.

The clearinghouse service 101 may comprise a webserver software module (webserver 117) hosted on one or more server computers, workstation computers, laptops, or tablets. The webserver 117 may be configured to execute any number of web services modules (e.g., Microsoft IISO, Apache®, Google GWS®), scripting engines, and other Internet-based services, to host an interactive web portal accessible to various client devices, such as an administrator device 119 or end user device 131. In some implementations, the webserver 117 may be configured to display various data records associated with the clearinghouse service 101 through a series of webpages. For example, the webserver may generate interactive webpages displaying to an administrator device 119 inbound records, schema files, records in a queuing or intermediate database, records in a domain repository 113, and/or records in a master repository 115, thereby allowing clearinghouse service administrators to configure and manage data flow among devices and to remediate complications identified in the system 100 or in the data.

In some implementations, the webserver 117 may be a means for publishing data to a client device 131 to view data stored in the repositories 113, 115. In such implementations, a client hospital may desire a web portal for viewing its data in a series of interactive views, which may query the data stored in, for example, a master repository 115 or domain repository 113. The webserver 117 may receive a series of database queries from a client device 131, via an interactive webpage hosted by the webserver 117. The webserver 117 may forward these queries to the data management server 111, which may query, for example, the master repository 115 for the various data fields satisfying the queries. The data management server 111 may structure the data fields according to a schema defined by the query, which may include a database “view” that defines the data fields a user wants displayed on the resulting webpage.

An administrator device 119 may be any computing device comprising a processor capable of executing software modules that perform the various tasks and processes described herein. Non-limiting examples of an administrator device 119 may include a server computer, a workstation computer, a laptop computer, a tablet, and mobile device (e.g., smartphone, PDA). The administrator device 119 may execute software modules allowing an administrator of the clearinghouse service 101 to configure the various aspects of the system 100. For example, the administrator device 119 may generate, monitor, and update inbound and outbound interface modules executed by the various data management servers 111. The administrator device 119 may be used to generate and distribute to the data management servers 111 the various schema files configured for the data sources 103 and destination devices 105. The administrator device 119 may be used to monitor the efficacy of the data conversion for data received from data sources 103 and data transmitted to the destination devices 105. In some instances, the administrator device 119 may be used to remediate complications. For example, an administrator may use the administrator device 119 to manually input or revise a data field that was inaccurately matched to a patient or inaccurately converted to a new data model.

Data Sources 103 may include any number of computing devices or machine-readable computer files providing the clearinghouse service 101 with inbound data records in any number of formats. For example, a data source 103 may be a healthcare application server 121 that generates healthcare records (i.e., inbound records) according to the particular data model of the healthcare application (e.g., AllScripts®, EPIC®, MatrixCare®, AOD®, eHealthcare®). In some cases, the inbound records may be transmitted to a server 111 of the clearinghouse service 101 over any number of internal and external data networks. As another example of a data source 103, the inbound data records may be scanned from paper documents and transmitted to a server 111 of the clearinghouse service 101. As another example, a data source 103 may include a data repository 123 storing records according to any number of data formats (e.g., XML, RSS, SQL, text file, RSS) and/or data models (e.g., HL7, CCD, Delta, customized model), and may be transmitted to a server 111 of the clearinghouse service 101 or may be fetched by the server 111 of the clearinghouse service 101 based on a triggering condition (e.g., time-based periodic updates, real-time updates).

The data sources 103 may include any number of healthcare application servers 121 executing healthcare applications that generate electronic healthcare records having a prescribed data model associated with the particular healthcare application. The data sources 103 may further include a data repository 123 containing healthcare records stored in an electronic format on one or more servers, or other non-transitory machine-readable storage media. The data sources 103 may be configured to provide the inbound records to the clearinghouse service 101 in any number of ways. For example, in some cases, a data repository 123 may be configured to periodically (e.g., daily) transmit via, say, FTP or SFTP, a batch of new or updated records to a data management server 111 of the clearinghouse service 101. As another example, the data management server 111 may communicate via a messaging service with an application server 121, thereby allowing the application server 121 to transmit in real-time new or updated records to the data management server 111, or prompting in real-time the data management server 111 to pull the new or updated records from the application server 121 or data repository 123.

Data destination devices 105 may be computing devices comprising non-transitory machine-readable storage media capable of receiving and storing data from any of the repositories of the clearinghouse service 101, where such repositories may include a queuing or intermediate database (not shown), domain repository 113, and/or master repository 115. In some cases, a destination device 105 may be any computing device comprising a processor capable of executing software applications configured to receive and view healthcare data records outputted by the clearinghouse service 101. Non-limiting examples of destination devices may include end user devices 131, destination application servers 133, destination data repositories 135, and servers hosting an analytics service 137. Each destination device 105 executes software modules configured for a particular data model. As such, an administrator device 119 may be used to generate and establish a schema file for the data models of each of the potential destination devices 105. A data management server 111 of the clearinghouse service 101 may execute one or more outbound interface modules that reference the appropriate schema file designed for a corresponding destination device 105. The outbound interface may structure the desired data according to the particular data fields defined by the schema file, to output appropriately formatted data to the destination device 105.

A user device 131 may be any computing device comprising a processor configured to execute a healthcare application or a web browser application that accesses or receives data records from the clearinghouse service 101. Non-limiting examples of a user device 131 may include a server computer, a workstation computer, a tablet device, and a mobile device (e.g., smartphone, PDA). In some instances, the user device 131 may execute a client-side healthcare application for manipulating or updating patient data. For example, a doctor may use a tablet device 131 configured to access patient records having a predefined data model. An outbound interface of a data management server 111 may structure and output to the user device 131 portions of the data stored in one or more master records of the master repository 115, according to a schema file configured for the particular user device 131. As another example, a web browser of the user device 131 may access data via a web portal hosted on a webserver 117 of the clearinghouse service 101.

A destination application server 133 may comprise a processor and network interfaces configured to host a network-accessible or cloud-based healthcare application or other application related to healthcare administration (e.g., finance, scheduling appointments). The application executed by the application server 133 may generate data records according to a particular data model. Similarly, the application executed by the application server 133 may need to receive data formatted according to the particular data model to properly interpret and manipulate the received data. As such, an outbound interface of a data management server 111 may be configured to format and transmit data to a destination application server 133 according to a schema file configured for the particular destination application server 133.

In some implementations, a subscribing entity, such as a customer, of the clearinghouse service may want inbound data records outputted to a particular subscriber data repository 135. This may be, for example, in circumstances where a subscribing entity (e.g., a hospital) is transitioning its systems from a legacy healthcare application to a new healthcare application that uses a different data model. In such circumstances, the subscribing entity may request for existing data having a legacy data model, stored in a source repository 123, to be outputted to a destination repository 135 and formatted according to a new data model.

An analytics service 137 (e.g., Hadoop®, Vertica®, Information Builders®) may be cloud-based or intra-network analytics engine executed on one or more server computers. An analytics engine may perform any number of analytics algorithms, such as cross-referencing data, and correlating data, and/or performing any number of metrics calculations, using data provided by the clearinghouse service 101. The analytics engine may require data to be defined by a schema file, according to domains or sub-domains. In some instances, the analytics engine may receive data tagged with any number of domain tags to cross-reference data records to generate data sets. In some implementations, data domains may be associated with various business domains, such as Clinical, Operational, Compliance, Benchmarking, and Financial. The domains may contain subjects (i.e., data fields or collection of data fields) that specify the entities and dimensions for the analytics used for generating analytics-based reports for a given business domain. For example, “credentialing” may be a subject supporting a Provider domain. In another example, a diabetes registry may be a subject-based dataset dedicated to the study of diabetic patients. In some instances, subjects may be further subdivided into cohorts to create particular datasets for their own purpose (e.g. women's health and HEDIS-measure datasets). The analytics engine of the analytics service 137 may cross-relate domains and subjects to discover various insights based on data relationships (e.g. cost of diabetes care for a cohort benchmarked against state and national sources). An administrator or the analytics engine of the analytics server 137 may therefore provide one or more schema files to an outbound interface, so that the data management server 111 may transmit the appropriate data records, structured with the appropriate data fields. In some implementations, the analytics service 137 may be executed by servers of the clearinghouse service 101. And in some implementations, the analytics service 137 may be executed by servers of a third-party subscribing entity, such as research institution.

Exemplary Architecture

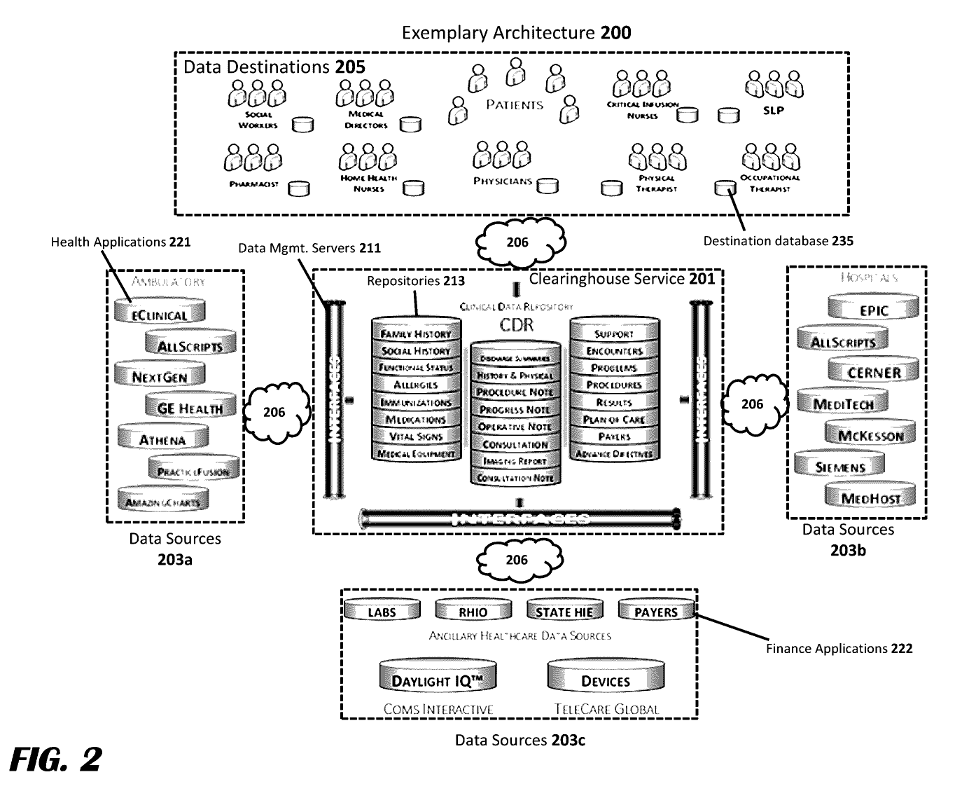

FIG. 2 shows components and organization of an exemplary architecture of an exemplary system 200 embodiment. The exemplary system 200 comprises a clearinghouse service 201 receiving data from various data sources 203(a)-(c), which include ambulatory care sources 203a, hospital sources 203b, and ancillary healthcare sources 203c. Data management servers 211 of the clearinghouse service 201 execute various interfaces for receiving and transmitting over one or more networks 206 data records having a variety of data models. The clearinghouse service 201 may output data to various data destinations, such application servers or destination databases 235, as proscribed by each particular subscribing entity in the data destinations 205.

Data sources 203(a)-(c) may produce and/or transmit inbound records for the clearinghouse service 201 using software applications of various types, include healthcare applications 211 designed for patient care and tracking (e.g., AllScripts®, NextGen®, EPIC®, McKesson®). In many cases, healthcare applications may produce, store, or otherwise utilize data having a somewhat standard data model, such as HL7, or some variant thereof. Interfaces of the data management servers 211 may be configured to interpret the data model for each data source 203(a)-(c), so that the various tasks and processes described herein may be performed, regardless of the particular data model of the source application. Likewise, ancillary data sources 203c may include software applications that may or may not be designed for the healthcare industry, but may be commonly used for healthcare administration. One example may include finance applications 222 that track payer information, claims, costs, and the like. Similar to healthcare-based data sources 203a, 203b, inbound data records from ancillary sources 203c may be formatted in a non-standard or varied way. Inbound interfaces of the data management servers 211 may be configured to interpret the inbound data records, and perform the various tasks and processes described herein.

The clearinghouse service 201 may store data in a clinical data repository 213 comprising records that are stored according to various domains, for each respective patient. That is, the clinical data repository 213 shows an exemplary collection of data field domains for a particular patient's master record. Data may be transmitted to data destinations, such as a physician, according to the data format expected by the physician's device or database 235. For example, the data may be formatted according to, say, HL7 formats, if the physician's application expects to receive data in that format. As another example, the data may be formatted into a Continuation of Care Document (CCD) comprising a predetermine collection of data fields, and transmitted to the physician's computing device or database 235 accordingly.

Exemplary Process of Data Integration

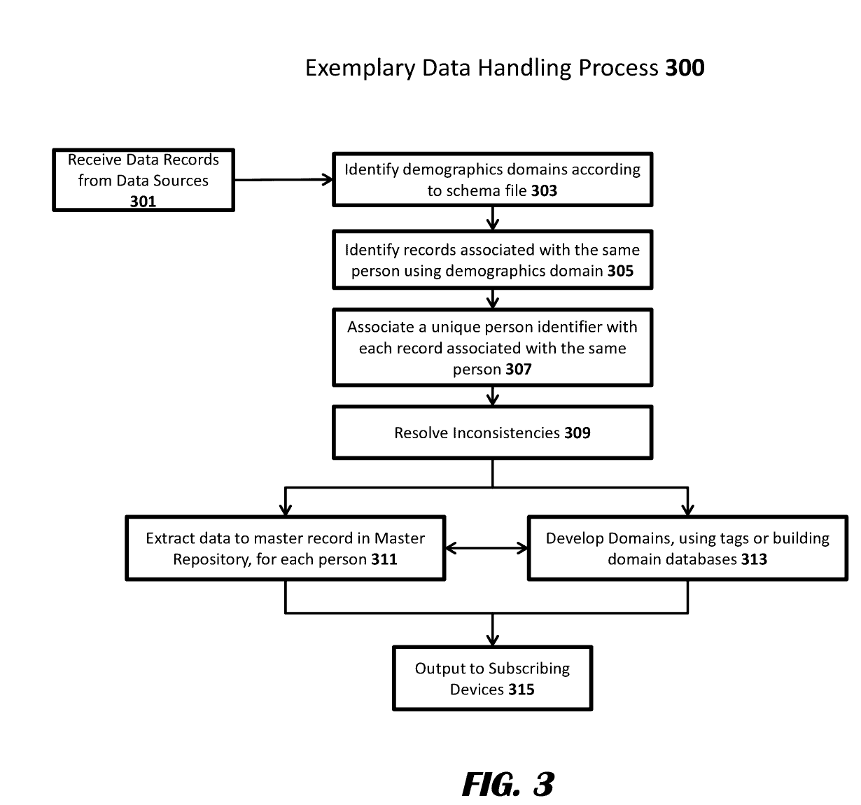

FIG. 3 shows an exemplary method 300 for data handling, as performed by one or more data management servers executing one or more interface modules. Execution of the exemplary method includes executing steps 301, 303, 305, 307, 309, 311, 313, and 315, as described below. However, one having ordinary skill in the art would appreciate that other embodiments may omit certain steps or may include additional or alternative steps. It should also be appreciated that other embodiments may execute the steps described below, as well as additional or alternative steps, in varied sequences. For example, inconsistencies in an inbound record may be resolved by an inbound interface before associating a unique patient identifier (patient ID) with matched inbound records, or afterward (as in the exemplary method 300).

In a first step 301, a data management server receives inbound data records from any number of data sources. The data management server may receive the inbound records at a period interval from a device of the data source. For example, a server of a data source may transmit a batch of inbound records nightly using an SFTP connection. In some cases, the data management server may query or be prompted to query a data source for updated or new data records (i.e., pull data from the data source). In some embodiments, inbound data records may be copied into a redundant database, where the records may be stored as a proof or baseline, thereby providing data redundancy and easy manual or automated data model-review. The redundant database may be configured for each respective data source, such that the data is not distorted by data arriving from other data sources. Additionally or alternatively, inbound records may also be stored into a queuing or intermediate database acting as a “sandbox” where the interfaces of the data management server may manipulate and update the data during execution.

In a next step 303, the data management server may reference schema files configured for the particular inbound records, to identify data fields of a demographics domain. The demographics domain may comprise data fields identifying a patient, such as name fields, age, gender, address, date of birth, social security number, Medicare number, Medicaid number, and the like. In some instances, these data fields may be parsed differently in each data model. For example, an inbound record of a first data model may have a “name” field comprising a first, middle, and last name of a patient, whereas an inbound record of a second data may have distinct “first name,” “middle name,” and “last name,” data fields. The schema file associated with the second data model may indicate to the data management server that the inbound records of the first data model need to be parsed into, or otherwise reviewed as having, distinct data fields for first, middle, and last names, thereby allowing for a similar comparison of inbound data records. Optionally, in the current step 303, the data management server may reference schema files to identify any number of domains in the inbound records. That is, domains may be defined by a certain set of data fields (and the types of data contained in those data fields). The schema files may be used to identify which, if any, of the data fields in the inbound records are members of one or more domains.

In a next step 305, the data management server may compare the data fields of the demographics domain to identify which inbound records pertain to the same patient. The comparison may require the data stored in the demographics data fields to match to a certain degree. That is, the data management server may identify that two inbound records are related to the same patient when the demographics satisfy a matching threshold value, which may be, say, a percentage of the total number of demographics fields, or a minimum threshold for the total number of matches.

In a next step 307, the data management server may generate and assign a unique patient ID to each inbound record or set of data fields related to a patient, based on the matching of a previous step 305. In some cases, the patient ID may be included as a data field to each inbound record associated with the patient. In some embodiments, the inbound records in the queuing database or domain database may now indicate one or more data fields associated with one or more domains, and may also indicate a patient ID associated with each respective inbound record, to include those matched to the same patient. As described in the subsequent step 311, inbound records matching the same patient ID may be merged (e.g., union, XOR) into the master record for the patient, such that the data fields are not unnecessarily duplicated, but the data fields associated with each respective domain are not lost.

In an optional next step 309, the inbound interface may identify and resolve inconsistencies in the records associated with the same patient. Defects in the data fields may be identified during comparisons, and may be revised or updated according to any number of techniques. For example, the data management server may be configured to select the data value that is most prevalent for a corresponding data field. In some embodiments, an administrator device may be used to manually identify and/or remedy inaccuracies in the data fields of inbound records or master records. Inconsistencies may also include standardization of the data fields, such expected data types for a data field (e.g., text, number, integer, timestamp, date formats), justification (left justified, right justified), capitalization (upper/lower/mixed), phone number, email address, postal addressing standardizations, and differences in an industry-code set (e.g. patient gender codes, patient type codes).

In a next step 311, the data management server may populate a master repository with master records of patients. The master records may include a longitudinal record for each patient. In this step, the data management server may generate a new master record or update an existing master record, for each unique patient ID. New master records may be generated when inbound records are not matched within a threshold to a master record having the patient ID already stored in the master repository. Master records may be updated with additional data from inbound records when the demographics data of the inbound record matches the demographics data of an existing master record assigned a patient ID. In some implementations, each new inbound record is independently compared against the master records to determine whether the new inbound record is related to the same patient of an existing record. In some implementations, one or more new inbound records may be compared against one another to determine whether they are related to the same patient, and then the group may be compared against the existing records of the master repository. Updating master records for a patient ID may include appending one or more data fields of a new inbound record as a record entry to the master records of a patient, when the inbound record has been assigned the corresponding patient ID. Additionally or alternatively, updating master records for a patient ID may include merging one or more data fields to an existing record entry associated with a particular treatment regimen, as identified in certain data fields of the inbound records by the data management server referencing the schema file and/or industry-standard treatment codes.

In some embodiments, in the current step 311, the data management server may benefit from efficiencies provided by domain-based tagging or parsing, when populating or updating the master repository.

The use of domains may provide efficiencies in reviewing the data, and may prevent unwanted redundancies that may occur when trying to search or merge whole inbound records. For example, the data management server may retrieve and compare only those data fields tagged or parsed as demographics data. If there is a match to patient ID in the master repository, the inbound record and/or data fields may be assigned the patient ID. The data management server may then query inbound records having the patient ID and then merge with the existing master record, only those data fields tagged or parsed as being in a particular domain. This negates the need to merge an entire inbound record and then discard the superfluous demographics data, which is already known because the master records for a patient ID already contain demographics data tagged with the patient ID. Of course, the demographics data may have changed, in which case, tagging or parsing demographics data, as well as other domains, may help the data management server to more efficiently identify changes in the information, may require updating. In other words, domain-based tagging or parsing facilitates more efficient storage, as fewer and smaller records are generated, and quicker retrieval of the data stored in various databases, such as a queuing database or domain database, when generating master records.

In some implementations, the development of domains corresponding to various categories for logically grouping data fields may be developed by associating one or more domain tags with each of the data entries into master records of patients. In some implementations, the system may generate a domain database where the data of each master record may be populated, according to the particular parameters of a domain. In some implementations, this may provide for more efficient storage, by eliminating redundant or superfluous data fields. This may also provide for more efficient searching of records stored in the master repository, as queries or data sets may be constructed or defined by domain tags for downstream, destination devices. As an example, an analytics service may request only certain data sets, such as demographics data and treatment data for certain illnesses, so that the analytics algorithms may identify various correlations between, say, genders, illnesses, and ineffective treatment regimes. To this end, the data fields of the master records may be tagged according to a schema file, which may be defined according to data source or a destination device.

As noted in step 303, data fields of inbound records may be tagged or parsed into domains, according to a schema file for the particular data model of the inbound record, before populating or updating a master repository. That is, the data management server may be able to assess, then merge or append, only those portions of inbound records that are tagged or grouped with certain domains. These domains created at step 303 can be maintained and used in the population or update of the master repository.

In the event the domains were not defined at step 303 or in case a different set of domains is desired for the population or updating of the master repository, the system provides next step 313 which can occur before, after, or both before and after step 311. Next step 313 is again the definition of domains. Conducting step 313 prior to 311 enables the system to either define domains in the event no domains were defined in step 303 or maintained from step 303, or redefine domains in the event domains different from those set in step 303 are desired to use in the population or update of the master repository.

After populating or updating master records, the system may maintain the domains used for the population or update of the master records or vary them depending on the desired application of the master records. In exemplary embodiments, step 313 can be carried out after step 311, independent of whether step 303 and/or 313 were also carried out before step 311.

The stored data in the master repository or other databases (e.g., queuing database, backup database, domain repository) may be parsed or tagged again, according to an outbound schema file. In this embodiment, a destination device, such as an analytics service, may desire more granular data sets, rather than all of the data tagged in a domain. Thus, an outbound schema file may indicate, data fields defining domains, cohorts, or other data sets, as expected by the particular destination device. In some embodiments, the tagged or parsed data fields may then be populated as records of a reporting repository or domain repository comprising one or more database tables configured to provide data at various levels of granularity.

In a next step 315, an output interface of a data management server may select a set of data fields from a master repository, domain repository, or reporting repository, according to a schema file configured for a destination device's data model specification, such as HL7, CCD, or other data structure schema. The output data may be transmitted by server (e.g., data management sever, webserver) over an internal and/or external network to a destination device, according to any number of protocols, and in a format and machine-readable file-type proscribed by the output interface and schema file.

Exemplary Implementation

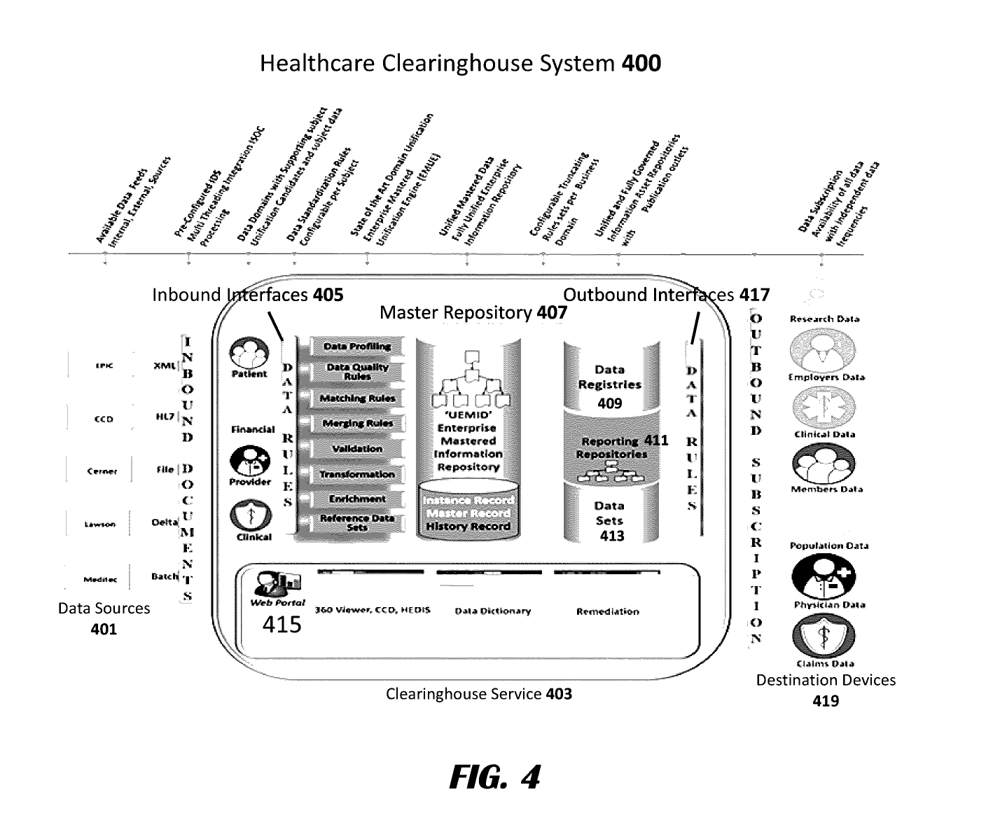

FIG. 4 shows data flow between devices of a clearinghouse system 400, according to an exemplary embodiment. In the exemplary system 400, an instance of a master repository 407 may be established on behalf of a client entity, such as a long-term care facility. Inbound interfaces 405 executed by one or more data management servers may consume data, by pulling data, receiving data, or both, from various data sources 401. The inbound interfaces 405 may execute a number of processes for normalizing the inbound records received from the data sources. For example, the inbound interface 405 (i.e., preconfigured inbound orchestration specification (ISOC)) may execute a number of data profiling rules to define the data fields of the inbound data according to schema files configured for the data models of the inbound records. The inbound interfaces 405 may further assign domains (e.g., Patient, Financial, Provider, Clinical) to inbound records, or sets of data fields (i.e., subjects of a domain), according to the schema file of the respective data source 401. The inbound interface 405 may then match inbound records pertaining to the same patient, and generate a unique patient identifier (“patient ID” or “UID”) for the matching records.

An enterprise master information repository (master repository 407) of the clearinghouse service 403 may comprise master records for patients containing cross-domain data sets received from each respective data source 401, even when the data sources 401 utilize distinct data models and are related to distinct domains. When an inbound interface 405 identifies inbound records from various data sources 401 matched within a certain threshold (e.g., 75%), based on a comparison of data fields in a demographics or Patients domain, the matched data records are considered to be associated with the same patient, and are thus assigned a patient ID. Each inbound record or set of data fields receiving a patient ID, even those that are not matched to another inbound record, are stored into the master repository 407, as a master record for the particular patient associated with the patient ID. New inbound records may be compared against existing records, such as master records, stored in existing repositories, such as the master repository 407. The existing records may be associated with the patient ID, and as such, new inbound records may be assigned the patient ID when the inbound records have demographics data satisfying the matching threshold, when compared against the demographics data of one or more existing records already assigned the patient ID.

In some embodiments, data fields associated with the same patient ID may be merged into a master record, and stored into the master repository 407. Master records may be stored in any number of formats and structures, or may have no particular format or structure. According to some implementations, master records may be parsed into subsets by software modules of a data management server, such as an outbound interface 417. The data may be parsed according to domains, or other parameter set, into data registries 409 and/or reporting repositories 411. These databases 409, 411 may store data parsed from the master registry 407 according to various domains, subjects, or other parameters, for distribution to destination devices 419. The outbound interfaces 417, may generate data registries 409 (i.e., domain repositories) that store data records for various domains or data sources 401. Data sets 413 may store various subdivide collections data fields from various data records. Reporting repositories 411 may store and transmit data fields in a format useable by a target destination device, according to predefined schema file, referenced by the outbound interface 417.

The system described herein, can therefore provide a number of advantages over the existing applications. It provides an agnostic system that is able to implement interoperability of discrete medical records. In other words, the system can free health care information for each patient without the need to standardize the already existing industry practice. Instead of implementing standardization of data management, the system and process described herein can efficiently and accurately provide any one health care provider the ability to obtain a comprehensive and accurate record for each patient. The applications for such information are endless and can be applicable not only in the long term health care industry, where the problem of disparate data sources is most prevalent, but can also improve the information management in the acute health care practice. The system and methods described herein are able to make available a complete patient record to any device independent of the data system involved, including any desired mobile applications, allow the user to run any number of analytics, identify key performance indicators, and view the information in any number of different display modes.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A computer-implemented method to achieve interoperability between disparate electronic health record systems, the method comprising:
receiving, by a computer, one or more inbound records from one or more source devices, wherein each respective inbound record is received from a source device and comprises one or more data fields;
for each respective inbound record, identifying, by the computer, one or more domains in the inbound record according to a schema file configured for the inbound record, each domain defined by a set of one or more data fields of the inbound record, wherein at least one domain in the inbound record is a demographics domain;
assigning, by the computer, a unique patient identifier (patient ID) to each respective inbound record, wherein a set of two or more inbound records are assigned the same patient ID when the data in the demographics domain of each respective inbound record in the set of two or more inbound records satisfies a matching threshold value;
parsing, by the computer, each inbound record into the one or more sets of data fields defining the one or more domains identified in the respective inbound record, wherein respective set of data fields is associated with the patient ID;
for each respective patient ID:
merging, by the computer, into a master record identified by the respective patient ID the one or more sets of data fields defining the one or more domains; and
generating, by the computer, the master record in a master repository.

2. The method according to claim 1, wherein each schema file configured for the respective inbound record defines the one or more data fields of the respective inbound record.

3. The method according to claim 1, further comprising:
generating, by the computer, one or more outbound records from the records of the master repository according to an outbound schema file associated with a destination device; and
transmitting, by the computer, the one or more outbound records to the destination device.

4. The method according to claim 3, wherein generating the one or more outbound records further comprises:
generating, by the computer, in a reporting repository one or more domain records containing the one or more sets of data fields defining the one or more domains, wherein each respective domain record corresponds to a respective domain and comprises the set of data fields defining the respective domain.

5. The method according to claim 4, wherein generating the one or more outbound records further comprises:
selecting, by the computer, the one or more outbound records from the data fields of the one or more domain records, according to the outbound schema file configured for the destination device.

6. The method according to claim 1, wherein receiving the one or more inbound records from a data source further comprises:
receiving, by the computer, from the source device a message indicating at least one inbound record is new or updated; and
retrieving, by the computer, from the data source the one or more inbound records, including the at least one inbound record that is new or updated.

7. The method according to claim 1, wherein receiving the one or more inbound records from a data source further comprises:
generating, by the computer, a copy of each of the inbound records in a backup database corresponding to the source device.

8. The method according to claim 1, wherein parsing each inbound record according to the one or more domains indicated by the schema file further comprises:
storing, by the computer, into a reporting repository at least one set of data fields of at least one domain.

9. The method according to claim 1, further comprising identifying, by the computer, identifying one or more inconsistencies in data of a subset of data fields in a first inbound record as compared to the corresponding subset of data fields in a second inbound record.

10. The method according to claim 1, further comprising updating, by the computer, the master record of a patient ID upon receiving a new inbound record comprising data fields of the demographics domain satisfying the matching threshold in comparison to the set of data fields of the demographics domain in the master record for the patient ID.

11. The method according to claim 1, further comprising:
detecting, by the computer, a change to at least one data field in at least one inbound record received from a data source; and
dynamically, by the computer, updating the schema file configured for the data source and the inbound interface used for the data source.

12. A system to achieve interoperability between disparate electronic health record systems in long term care, the system comprising:
one or more inbound schema files defining one or more data fields of one or more inbound records and indicating one or more sets of the one or more data fields correspond to one or more domains;
an application programming interface executed by a server configured to receive one or more inbound records from one or more data sources, identify one or more data fields in each inbound record according to a schema file configured for the inbound record, and identify one or more domains in the one or more data fields of each respective inbound record according to the schema file;
a server executing a unification engine configured to merge one or more sets of data fields corresponding to domains for each set of data associated with a patient identifier (patient ID), and generate or update a master record in a master repository for each patient ID comprising at least one set of data fields for at least one domain for each set of data fields corresponding to the respective patient ID; and
an outbound interface configured to transmit one or more outbound records containing one or more data fields of domains parsed from one or more master records of the master repository according to an outbound schema file associated with one or more destination devices.

13. The system according to claim 12, further comprising one or more destination devices executing one or more software applications configured with one or more data models, each data model associated with at least one outbound schema file.

14. The system according to claim 12, further comprising at least one backup database storing the one or more inbound records received from a data source.

15. The system according to claim 12, wherein a data management server executing the application programming interface is configured to:
identify a change in at least one data field in a new inbound record received from a data source; and
dynamically update the target data elements defined by the preconfigured inbound data schema corresponding to the data source.

16. The system according to claim 12, further comprising a reporting repository comprising non-transitory machine-readable storage media configured to store one or more data records comprising at least one set of data fields corresponding to at least one domain parsed from the one or more master records of the master repository according to one or more data set parameters associated with an analytics engine.

17. The system according to claim 16, further comprising one or more servers hosting an analytics service, the analytics service executing an analytics engine configured to receive the one or more data records parsed from the one or more master records according to the one or more data set parameters from a data management server executing one or more outbound application programming interfaces, and to execute one or more analytics algorithms using the one or more data records.

18. The system according to claim 12, further comprising a mobile device of a user as a destination device, the mobile device configured to receive one or more data fields parsed from the master repository according to the outbound schema associated with the mobile device.

19. The system according to claim 12, further comprising a webserver as a destination device, the webserver configured to host one or more interactive webpages displaying the one or more data fields of domains according to one or more queries received from a user device.

20. A system for providing interoperable electronic health records between disparate data sources, the system comprising:
a data management server executing a plurality of inbound interfaces configured for a plurality of data sources, the data management server configured to:
receive one or more inbound records from one or more data sources:
assign a unique patient identifier (patient ID) to each inbound record comprising distinct data in a set of demographics data fields of the inbound record;
identify, in each respective inbound record, one or more sets of one or more data fields belonging to one or more domains; and
transmit to one or more destination devices one or more outbound records comprising one or more data fields of one or more domains, in accordance with one or more outbound schema files defining the one or more data fields for the one or more destination devices; and
a mobile device comprising a processor executing a mobile application operating according to a first data model, the mobile device configured to:
receive from the data management server an outbound record comprising a set of one or more data fields in one or more domains defined by a first schema file configured for the first data model, and
display the data of at least one data field of the outbound record on an interactive graphical user interface operated via the mobile application.
